(19) United States
(12) Patent Application Publication
(10) Pub. No.: US 2011/0079446 A1
(43) Pub. Date: Apr. 7, 2011

(54) EARTH-BORING TOOLS AND COMPONENTS THEREOF AND METHODS OF ATTACHING COMPONENTS OF AN EARTH-BORING TOOL

(75) Inventor: James A. Oxford, Magnolia, TX (US)

(73) Assignee: BAKER HUGHES INCORPORATED, Houston, TX (US)

(21) Appl. No.: 12/896,419

(22) Filed: Oct. 1, 2010

Related U.S. Application Data
(60) Provisional application No. 61/248,676, filed on Oct. 5, 2009.

(51) Int. Cl. E21B 10/36; B23K 20/12

(52) U.S. Cl. 175/425; 228/114.5

(57) ABSTRACT

Methods for welding a fixed-cutter bit body to a shank of an earth-boring bit are disclosed. An interface may be formed between the fixed-cutter bit body and the shank, and the interface may be friction stir welded. In some embodiments, the fixed-cutter bit body and the shank may overlap proximate to an exterior surface of the earth-boring bit. Methods for welding at least two portions of a bit body of a roller cone bit are also disclosed. An interface may formed between the at least two portions of the bit body of the roller cone bit and the interface may be friction stir welded. Earth-boring rotary drill bits formed using such methods are also disclosed.

### CROSS-REFERENCE TO RELATED APPLICATION

This application claims the benefit of U.S. Provisional Patent Application Ser. No. 61/248,676, filed Oct. 5, 2009, the disclosure of which is hereby incorporated herein in its entirety by this reference.

### TECHNICAL FIELD

Embodiments of the present invention relate generally to earth-boring drill bits and other tools that may be used to drill subterranean formations and to methods of manufacturing such drill bits and tools. More particularly, embodiments of the present invention relate to apparatus and methods for attaching components of the earth-boring drill bit or other tool, and resulting structures.

### BACKGROUND

Rotary drill bits are commonly used for drilling wellbores in earth formations. One type of rotary drill bit is the fixed-cutter bit (often referred to as a “drag” bit), which typically includes a plurality of cutting elements secured to a face region of a bit body. The bit body of a rotary drill bit may be formed from steel. Alternatively, a bit body may be fabricated to comprise a composite material. A so-called “infiltration” bit includes a bit body comprising a particle-matrix composite material and is fabricated in a mold using an infiltration process. Recently, pressing and sintering processes have been used to form bit bodies of drill bits and other tools comprising particle-matrix composite materials. Such pressed and sintered bit bodies may be fabricated by pressing (e.g., compacting) and sintering a powder mixture that includes hard particles (e.g., tungsten carbide) and particles of a metal matrix material (e.g., a cobalt-based alloy, an iron-based alloy, or a nickel-based alloy).

Conventionally, the bit body of the rotary drill bit configured as a drag bit is secured to a shank which has a threaded portion for attaching the drill bit to a drill string. If the bit body is formed from steel, the steel bit body may be attached to the shank and welded thereto. If the bit body is formed from particle-matrix composite material, a steel blank may be partially embedded in a crown of the bit body, the crown comprising the particle-matrix composite material. The steel blank is then attached to the shank and welded thereto.

Another type of rotary drill bit is a roller cone earth-boring bit, including, for example, a roller cone earth-boring drill bit using milled, usually hardfaced, steel teeth on the cones, inserts of tungsten carbide or inserts comprising a polycrystalline diamond compact on the cones. A roller cone earth-boring drill bit typically comprises at least two, and generally three, cones with teeth or inserts protruding from the surface of each cone for engaging and crushing the rock.

Conventionally, when manufacturing a roller cone earth-boring bit, the bit body is formed in a plurality of portions, each portion including at least one bit leg and a cone rotatably mounted to a bearing pin on each bit leg. At least two of the plurality of portions are then welded together along a longitudinal seam to form the bit body.

In conventional welding of rotary earth-boring tools, a channel or weld groove is formed along an interface of the at least two surfaces to be welded. A metallic material or “filler material” such as, for example, an iron-based alloy, a nickel based alloy, or a cobalt-based alloy is deposited within the weld groove to weld the at least two surfaces. The filler material may be deposited using, for example, an arc welding process such as submerged arc welding (SAW), gas metal arc welding (GMAW), flux-cored arc welding (FCAW), and other arc welding techniques known in the art.

Arc welding processes and other welding processes that require the use of a filler material may have several disadvantages. Firstly, multiple depositions of the filler material may be required in order to achieve the desired thickness of filler material in the weld groove, thus making the process time consuming. Similarly, the materials to be welded must be prepared in advance to form the weld groove in which to apply the filler material, which also requires time and expense. Additionally, as the filler material solidifies, discontinuities may form in the filler material which may result in cracks or differing porosity throughout the material which may weaken the weld and ultimately result in failure of the drill bit. Furthermore, the weld processes themselves may release dangerous or toxic fumes and/or may cause the filler material to spatter during deposition.

In view of the above, it would be advantageous to provide methods and associated systems that would enable the welding of a drag bit bit body to a shank, welding portions of a roller cone bit body, or portions of another earth-boring tool with at least the same weld strength as conventional welding processes, but without the disadvantages associated with conventional arc welding.

### BRIEF SUMMARY

In some embodiments, the invention includes methods of forming an earth-boring drill bit. The method may comprise forming an interface between a bit body of the earth-boring drill bit and a steel shank of the earth-boring drill bit. The interface may be friction stir welded to secure the bit body to the steel shank. The interface may be friction stir welded by applying a rotating tool to the interface to cause friction between the rotating tool and the interface, inserting at least a portion of the rotating tool into the interface, and moving the rotating tool across an exterior surface of the earth-boring drill bit along the interface. In some embodiments, the bit body and the steel shank may be configured to overlap proximate the exterior surface of the earth-boring drill bit so that the at least a portion of the rotary tool is inserted through both the bit body and the steel shank.

In additional embodiments, the invention includes methods of forming an earth-boring drill bit, the method comprising forming at least two portions of the earth-boring rotary drill bit, each portion comprising a bit leg for rotatably mounting a roller cone thereon, assembling the at least two portions to form an interface between the at least two portions, and friction stir welding the interface to secure the at least two portions. In some embodiments, the weld may be effected after the roller cones are mounted to the bit legs.

In additional embodiments, the invention includes earth-boring rotary drill bits including a bit body and a shank secured to the bit body forming an interface between the bit body and the shank. The interface is friction stir welded around an exterior surface of the earth-boring drill bit.

In yet additional embodiments, the invention includes earth-boring rotary drill bits including a body having at least two portions, each portion comprising a bit leg having a roller cone mounted thereon, the roller cone rotatable on the bit leg about a rotation axis. An interface between the at least two portions along a longitudinal axis of the body is friction stir welded.

### BRIEF DESCRIPTION OF THE SEVERAL VIEWS OF THE DRAWINGS

While the specification concludes with claims particularly pointing out and distinctly claiming what are regarded as embodiments of the invention, various features and advantages of embodiments of the invention may be more readily ascertained from the following description of some embodiments of the invention, when read in conjunction with the accompanying drawings, in which:

FIG. 1 is a side, partial sectional elevation of an earth-boring rotary drill bit having a bit body welded to a shank, according to embodiments of the present invention;

FIG. 2 is an enlarged perspective view of an interface between a bit body and a shank of the earth-boring rotary drill bit being welded, according to embodiments of the present invention;

FIG. 3 is a simplified close-up cross-sectional view of a one embodiment of a portion of an interface configuration usable between a bit body and a shank of an earth-boring rotary drill bit as generally shown in FIG. 1;

FIG. 4 is a simplified close-up cross-sectional view of another embodiment of a portion of an interface between a bit body and a shank of an earth-boring rotary drill bit as generally shown in FIG. 1; and

FIG. 5 is a perspective view of another embodiment of an earth-boring rotary drill bit having at least one portion of a bit body including a bit leg welded to another portion of the bit body including a bit leg according to embodiments of the present invention.

### DETAILED DESCRIPTION

Some of the illustrations presented herein are not meant to be actual views of any particular material, device, or system, but are merely idealized representations which are employed to describe the present invention. Additionally, elements common between figures may retain the same numerical designation.

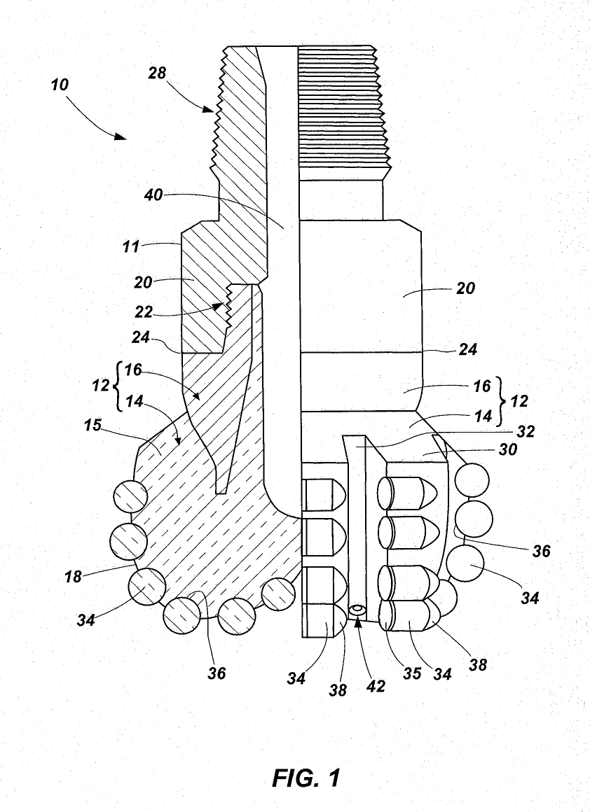

An embodiment of an earth-boring rotary drill bit 10 according to the present invention is shown in FIG. 1. As depicted, rotary drill bit 10 is configured as a fixed-cutter, or drag bit. The rotary drill bit 10 is a particle-matrix composite material type bit and includes bit body 12 secured to a shank 20 by way of a threaded connection 22 between steel blank 16 of bit body 12 and steel shank 20 and welding an interface 24 between the bit body 12 and the shank 20 using a solid-state joining process (e.g., a friction stir welding (FSW) process) as described in more detail below. The interface 24, as used herein, may refer to a boundary region between a portion of the bit body 12 and a portion of the shank 20 adjacent to each other. As depicted in FIG. 1, the interface 24 is configured as a so-called “butt joint,” wherein flat faces (in this instance annular flat faces) of blank 16 and shank 20 are placed in abutting relationship. The shank 20 may have a threaded connection portion 28 (e.g., an American Petroleum Institute (API) threaded connection portion) for attaching the drill bit 10 to a drill string (not shown). In some embodiments, and as shown in FIG. 1, the bit body 12 may include a crown 14 and a steel blank 16. The steel blank 16 may be partially embedded in the crown 14. The crown 14 may include a particle-matrix composite material 15, such as, for example, particles of tungsten carbide embedded in a copper alloy matrix material. In additional embodiments, the bit body 12 may be formed by machining a cast or forged steel billet, as known in the art. In further embodiments, the bit body 12 may be formed of a particle-matrix composite material 15 without the use of a steel blank 16. In all embodiments, an interface between a portion of the bit body 12 and a shank 20 may be friction stir welded.

The bit body 12 may further include wings or blades 30 that are separated by junk slots 32. Internal fluid passageways (not shown) extend between the face 18 of the bit body 12 and a longitudinal bore 40, which extends through the steel shank 20 and partially through the bit body 12. Nozzle assemblies 42 also may be provided at the face 18 of the bit body 12 within the internal fluid passageways.

A plurality of cutting elements 34 may be attached to the face 18 of the bit body 12. Generally, the cutting elements 34 of a fixed-cutter type drill bit have either a disk shape or a substantially cylindrical shape. A cutting surface 35 comprising a hard, super-abrasive material, such as polycrystalline diamond, may be provided on a substantially circular end surface of each cutting element 34. Such cutting elements 34 are often referred to as polycrystalline diamond compact (PDC) cutting elements 34. The PDC cutting elements 34 may be provided along the blades 30 within pockets 36 formed in the face 18 of the bit body 12, and may be supported from behind by buttresses 38, which may be integrally formed with the crown 14 of the bit body 12. Conventionally, the PDC cutting elements 34 may be fabricated separately from the bit body 12 and secured within the pockets 36 formed in the outer surface of the bit body 12. A bonding material such as an adhesive or, more typically, a metal alloy braze material may be used to secure the PDC cutting elements 34 to the bit body 12.

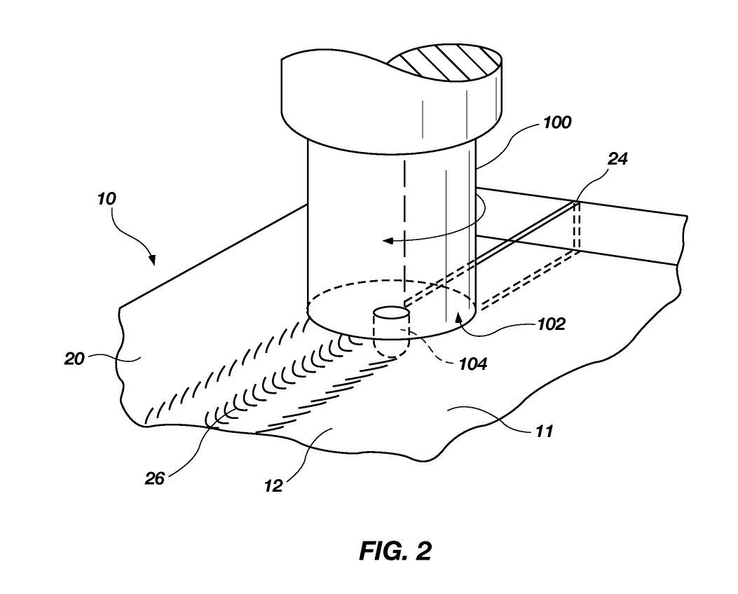

FIG. 2 is an enlarged perspective view of an interface 24 between the bit body 12 and the shank 20 being welded by friction stir welding, the exterior surfaces of bit body 12 and shank 20, as well as the interface 24 therebetween shown linearly, for clarity, rather than of arcuate configuration as will be apparent from a review of FIG. 1. Generally, a cylindrical rotating tool 100 comprising titanium or a ceramic material and having a shoulder 102 and a pin 104 extending outward from the shoulder 102 may be rotated against the interface 24 between the bit body 12 and the steel shank 20, causing the temperature at the interface 24 to increase due to friction between the rotating tool 100 and the materials of the bit body 12 and steel shank 20. The frictional heat causes the materials of the bit body 12 and the shank 20 to soften or plasticize. The materials of the bit body 12 (such term including steel blank 16 if present) and the shank 20 may plasticize without reaching the melting point of the material of the bit body 12 or the shank 20. For example, the materials of the bit body 12 and the shank 20 may plasticize at a temperature that is about eighty percent (80%) of the melting temperature of the materials of the bit body 12 and the shank 20. Thus, it may be desirable to friction stir weld at a maximum temperature that is on the order of about eighty percent (80%) of the melting temperature of the materials of the bit body 12 and the shank 20. When materials of the bit body 12 and the shank 20 plasticize at the interface 24, the pin 104 may be inserted into the interface 24. The drill bit 10 may be firmly supported to carry the load required to force the pin 104 of the rotating tool 100 into the interface 24 as the materials of the bit body 12 and the shank 20 plasticize.

Once the pin 104 is inserted into the interface 24, the tool 100 may be moved along the location of the interface 24, to create a weld as the plasticized material of the bit body 12 and the shank 20 flows around the pin 104. The rotating tool 100 provides continual friction and, thus, heat which plasticizes the material of the bit body 12 and the steel shank 20 at the interface 24 allowing mechanical deformation of the material of bit body 12 and the steel shank 20 at the interface 24. As the rotating pin 104 transports plasticized material from each of the bit body 12 and the steel shank 20 about the pin 104 into contact with the material of the other of the bit body 12 and the steel shank 20, the materials from a portion of the bit body 12 and a portion of the steel shank 20 proximate to the interface 24 are mixed, forming a solid phase bond or weld between the bit body 12 and the steel shank 20 consisting essentially of the materials of the adjacent portions of the bit body 12 and the steel shank 20. This is achieved through a combination of the aforementioned frictional heating and mechanical deformation of the involved materials of the bit body 12 and the steel shank 20. The shoulder 102 of the tool 100 may also contact the exterior surface 11 of the bit 10 causing additional frictional heat that plasticizes a larger region of material around the inserted pin 104. As a consequence, the shoulder 102 of the tool 100 may be used to cause the materials of the bit body 12 and the steel shank 20 to mix beyond the width of the pin 104. The shoulder 102 of the tool 100 may also provide a forging force to contain or force inward any tendency toward outward material flow caused by the tool pin 104. In some embodiments, the shoulder 102 of the tool 100 may be configured to conform to the curvature of the exterior surface 11 of the rotary drill bit 10.

The tool 100 may be moved transversely across the drill bit 10, the term “transversely” being indicative of a direction perpendicular to a longitudinal axis of drill bit 10 and around the lateral circumference thereof, to form a weld extending around the drill bit 10 on an exterior surface 11 thereof along the interface 24 of the bit body 12 and the steel shank 20. The tool 100 may be caused to travel along the interface 24 at a speed of, for example, 10 to 500 mm/min with the pin 104 rotating at rate of 200 to 2000 rpm. The tool 100 may be moved manually around the drill bit 10, or the tool 100 may be moved using an automated (e.g., robotic) process. For example, the tool 100 may be mounted to a heavy duty mill (not shown) capable of applying a high load to the tool 100. The mill may be configured to automatically move in a circumferential direction around the drill bit 10 along the interface 24 at the desired speed along the interface as tool 100 is rotated against the drill bit 10.

The resultant weld 26 at the interface 24 of the of the bit body 12 and the steel shank 20 may include a substantially defect-free, recrystallized, fine grain microstructure mixture of the materials of the bit body 12 and the steel shank 20. Because the friction stir welding is conducted at a temperature below the melting point of the respective materials of the bit body 12 and the steel shank 20, the weld 26 may be substantially free of solidification discontinuities such as, for example, cracks or increased porosity. Additionally, because the friction stir welding is done at the interface 24 between the bit body 12 and the steel shank 20 without the use of a filler material, preparation of the interface 24, such as forming a groove for receiving filler material, may not be required before welding. Friction stir welding the interface 24 may also be completed in a single, full penetration pass around the drill bit 10, which process may be more time efficient than conventional welding with a filler material that may require multiple applications. In addition, there is minimal distortion of the components welded, and higher weld speeds are achievable than with arc welding. Furthermore, because the friction stir welding process does not include a filler material or temperatures higher than the melting temperatures of the bit body 12 and the steel shank 20, there are no fumes produced or spattering of filler material. Also, because the friction stir welding process may be predominantly or entirely automated, there may be little or no inconsistencies introduced into the weld 26 associated with operator error or lack of skill.

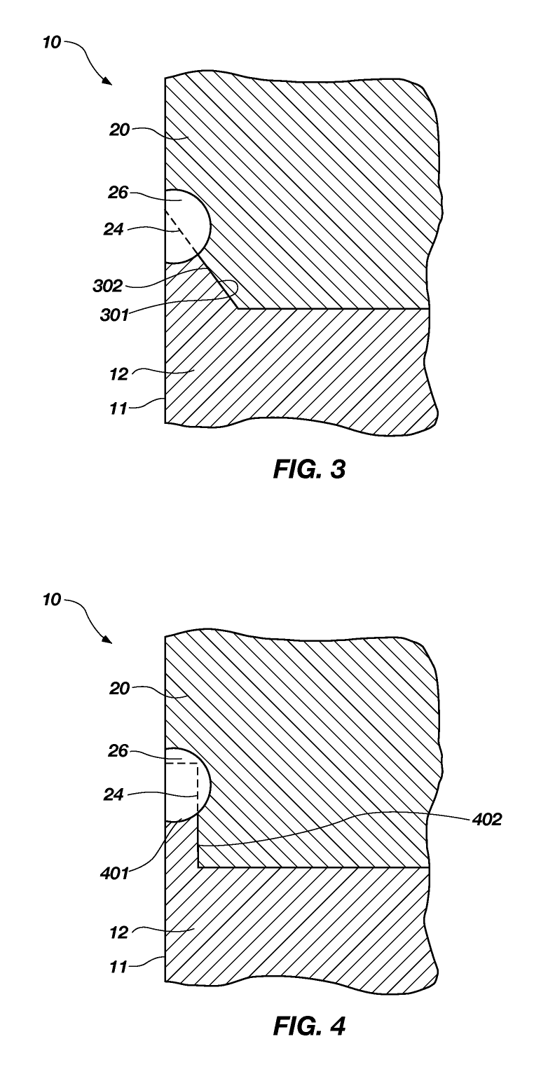

FIGS. 3 and 4 are enlarged cross sectional views of embodiments of an interface 24 and a weld 26 at an interface 24 between a shank 20 and a bit body 12 (again, such term including steel blank 16 if present) of a rotary drill bit 10 of the general configuration depicted in FIG. 1. As discussed above, the geometry of the interface 24 may be configured so that the materials of the bit body 12 and the steel shank 20 overlap along a circumferential area of the drill bit 10, perpendicular to the longitudinal axis of the drill bit 10 and proximate the radially outer extent of the drill bit 10. As illustrated in FIGS. 3 and 4, the geometry of the interface 24 may be configured so that the materials of the bit body 12 and the steel shank 20 overlap so that the interface 24 between the bit body 12 and the steel shank 20 is modified as the pin 104 of the tool 100 is inserted into drill bit 10. Configuring the interface 24 to change as the pin 104 of the tool is inserted into the drill bit 10 may improve the mixing of the materials of the bit body 12 and the shank 20 during the friction stir welding. The dashed portion of the interface 24 within the weld 26 (i.e., a portion of the path of the pin 104 through the drill bit 10) indicates the geometry of the interface 24 prior to the stir friction welding. For example, as illustrated in FIG. 3, in one embodiment, the steel shank 20 and the bit body 12 may have complimentary beveled, frustoconical edges 301, 302 near the exterior surface 11 of the drill bit 10. In another embodiment, as illustrated in FIG. 4, a portion of the bit body 12 may be formed with an annular protrusion 401 extending vertically along the exterior surface 11 of the drill bit 10. The steel shank 20 may be formed with an annular recess 402 on the exterior thereof to accept the protrusion 401. Of course, a butt joint configuration for interface 24 may be employed, as depicted in FIG. 1 and described above.

In some embodiments, the shank 20 and the blank 16 of the bit body 12 may comprise a low alloy steel (e.g., 1018 carbon steel, 4130 alloy steel, 8620 low alloy steel, or any steel alloy having a carbon content less than about 0.30 wt. %), and the shank 20 joined to the blank 16 by friction stir welding. Alternatively, the entire bit body 12 may be formed of a low alloy steel, as known in the art, and joined to the shank 20 by friction stir welding.

In additional embodiments, the bit body 12 may be formed of a particle-matrix composite material without the addition of the steel blank 16. The particle-matrix composite material bit body 12 may then be friction stir welded directly to the steel shank 12. Methods and systems for friction stir welding particle-matrix composites material are disclosed in, for example, U.S. Patent Publication No. 2006/0108394 entitled Method For Joining Aluminum Power [sic] Alloy to Okaniwa et al. the entire disclosure of which is incorporated herein by this reference. A similar method and system may be used to friction stir weld the particle-matrix composite material bit body 12 to the shank 20. By friction stir welding the bit body 12 and the steel shank 20, the metal matrix material of the bit body 12 may be plasticized and mixed with the material of the shank 20 to form the weld 26.

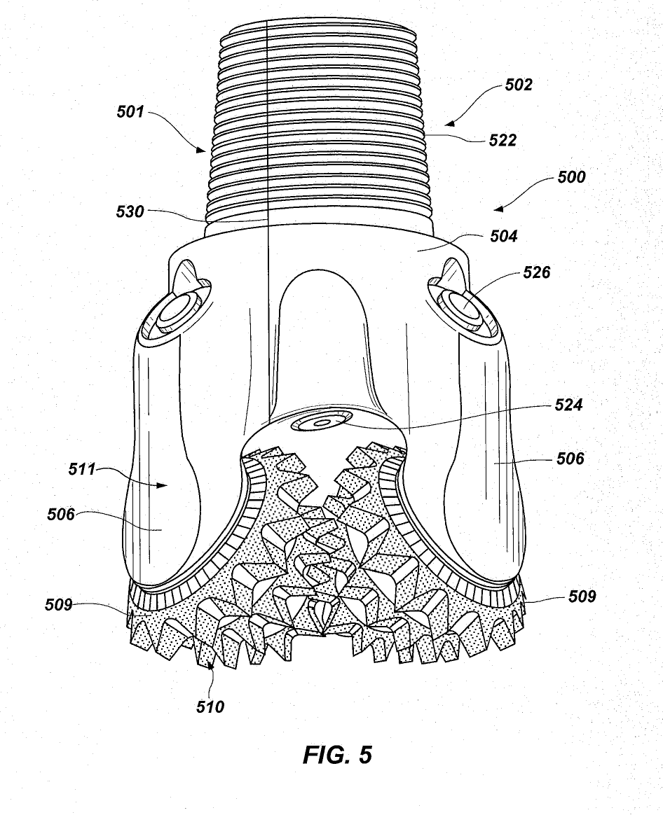

Another embodiment of an earth-boring rotary drill bit 500 of the present invention is shown in FIG. 5 as a non-limiting example of a drill bit employing a plurality of roller cones. The drill bit 500 comprises a bit body 504 having three bit legs 506. A roller cone 509 is rotatably mounted to a bearing pin (not shown) on each of the bit legs 506. Each roller cone 509 may comprise a plurality of teeth 510. The drill bit 500 has a threaded section 522 at its upper end for connection a drill string (not shown). The drill bit 500 has an internal fluid plenum that extends through the bit body 504, as well as fluid passageways that extend from the fluid plenum to nozzles 524. During drilling, drilling fluid may be pumped down the center of the drill string, through the fluid plenum and fluid passageways, and out the nozzles 523.

Each bit leg 506 also may include a lubricant reservoir for supplying lubricant to the bearing surfaces between the roller cones 509 and the bearing pins on which they are mounted. A pressure compensator 526 may be used to equalize the lubricant pressure with the boreholes fluid pressure, as known in the art.

The drill bit 500 may be formed by forming at least two portions (e.g., portions 501, 502) of the drill bit 500, each portion comprising a bit leg 506 and a roller cone 509 attached to the bit leg 506. Conventionally, a modern roller cone bit usually comprises three portions such as 501, 502, and so is characterized as a “tri-cone” bit due to the presence of three roller cones 509, each mounted to one bit leg 506. However, for simplicity, only two portions 501, 502 are depicted, there being another portion not shown behind portions 501, 502 in the drawing figure. The portions 501, 502 of the drill bit 500 may each comprise a longitudinally divided one-third of the drill bit 500 that includes at least one bit leg 506 and extends up through the threaded section 522. The portions 501, 502 of the drill bit 500 may be assembled to form an interface 530 between the portions 501, 502. The interface 530 may comprise a longitudinal seam along the bit body 504 between the portions 501, 502. The interface 530 may be welded using the friction stir welding techniques of embodiments of the present invention as previously described herein.

In some embodiments, the portions 501, 502 of the drill bit 500 may be configured to overlap at the interface 530 at an exterior surface 511 of the drill bit 500. Accordingly, the interface 530 between the portions 501, 502 of the drill bit 500 may be configured to appear substantially similar to the interface 24 described in FIGS. 3 and 4 above.

In light of the above disclosure it will be appreciated that the devices and methods depicted and described herein enable effective welding of particle-matrix composite materials. The invention may further be useful for a variety of other applications other than the specific examples provided. For example, the described systems and methods may be useful for welding and/or melting of materials that are susceptible to thermal shock. In other words, although embodiments have been described herein with reference to earth-boring tools, embodiments of the invention also comprise methods of welding other bodies comprising particle-matrix composite materials.

While embodiments of the present invention have been described and depicted in the context of rotary drill bits configured as drag bits and roller cone bits, embodiments of the present invention may be implemented for use in other earth-boring tools, such term including, by way of non-limiting example, so-called “hybrid” bits employing both fixed cutting structures and rolling elements, as well as tools used for enlarging well bores, and including without limitation eccentric bits, bicenter bits, fixed-wing reamers, expandable reamers, and milling tools. Accordingly, the terms “body,” “bit body,”, “blank” and “shank” are used expansively to encompass components of the foregoing tools, wherein the same techniques may be employed and equivalent structures produced. The term “bit,” as used herein likewise encompasses any and all of the foregoing tools.

While the invention may be susceptible to various modifications and alternative forms, specific embodiments of which have been shown by way of example in the drawings and have been described in detail herein, it should be understood that the invention is not intended to be limited to the particular forms disclosed. Rather, the invention includes all modifications, equivalents, and alternatives falling within the scope of the invention as defined by the following appended claims and their legal equivalents.

1. A method of forming an earth-boring drill bit, the method comprising:
forming an interface between a bit body of the earth-boring drill bit and a steel shank of the earth-boring drill bit; and
friction stir welding the steel shank to the bit body along the interface.

2. The method of claim 1, wherein friction stir welding along the interface comprises:
applying a rotating tool to the interface causing friction between the rotating tool and a portion of the bit body and a portion of the steel shank;
inserting at least a portion of the rotating tool into the interface; and
moving the rotating tool transversely across an exterior surface the earth-boring drill bit along the interface.

3. The method of claim 2, wherein further comprising configuring the bit body and the steel shank to overlap along a radial axis of the earth-boring drill bit so that the at least a portion of the rotating tool is inserted through material of both the bit body and the steel shank.

4. The method of claim 3, wherein configuring the bit body and the steel shank to overlap along a radial axis of the earth-boring drill bit comprises forming the bit body and the steel shank with complementary beveled, frustoconical edges proximate to an exterior circumferential surface of the earth-boring drill bit.

5. The method of claim 3, wherein configuring the bit body and the steel shank to overlap along a radial axis of the earth-boring drill bit comprises:
forming the bit body to have at least one annular protrusion extending vertically along the exterior surface of the earth-boring drill bit; and
forming the steel shank to have at least one annular recess configured to receive the at least one annular protrusion.

6. The method of claim 1, wherein friction stir welding the steel shank to the bit body along the interface comprises heating the interface to a temperature of less than about eighty percent (80%) of the melting temperature of bit body and the steel shank.

7. A method of forming an earth-boring rotary drill bit, comprising:
forming at least two portions of the earth-boring rotary drill bit, each portion comprising a bit leg configured to carry a roller cone;
assembling the at least two portions to form an interface between the at least two portions; and
friction stir welding the interface to secure the at least two portions.

8. The method of claim 7, wherein assembling the at least two portions to form an interface between the at least two portions comprises forming a longitudinal seam between the at least two portions.

9. The method of claim 7, wherein friction stir welding the interface to secure the at least two portions comprises:
applying a rotating tool to the interface causing friction between the rotating tool and a portion of each of the at least two portions;
inserting at least a portion of the rotating tool into the interface; and
moving the rotating tool transversely across an exterior surface of the earth-boring rotary drill bit along the interface.

10. The method of claim 9, wherein inserting at least a portion of the rotating tool into the interface comprises inserting a portion of the rotating tool into the interface so that a shoulder of the rotating tool abuts the exterior surface of the earth-boring rotary drill bit.

11. The method of claim 10, further comprising preventing outward flow of materials of the each of the at least two portions with the shoulder of the rotating tool.

12. An earth-boring rotary drill bit comprising:
a bit body; and
a shank secured to the bit body along an interface between the bit body and the shank, the interface comprising a friction stir weld extending around an exterior portion of the earth-boring rotary drill bit.

13. The earth-boring rotary drill bit of claim 12, wherein the bit body comprises a particle-matrix composite material.

14. The earth-boring rotary drill bit of claim 13, further comprising a steel blank embedded in the particle-matrix composite material, and wherein the friction stir weld comprises material of the shank and the steel blank.

15. The earth-boring rotary drill bit of claim 12, wherein a portion of the bit body and a portion of the shank overlap proximate to an exterior surface of the earth-boring rotary drill bit.

16. The earth-boring rotary drill bit of claim 12, wherein the friction stir weld extending around an exterior portion of the earth-boring rotary drill bit comprises a recrystallized, fine grain microstructure of a mixture of a material of the shank and a material of the bit body.

17. The earth-boring rotary drill bit of claim 12, wherein the friction stir weld is at least substantially free of cracks.

18. An earth-boring drill bit, comprising:
a body having at least two portions, each portion comprising at least one bit leg;
a roller cone mounted to the at least one bit leg and rotatable on the bit leg about a rotational axis; and
a friction stir weld proximate an exterior surface of the earth-boring drill bit along an interface between the at least two portions.

19. The earth-boring drill bit of claim 18, wherein the at least two portions overlap at the interface proximate to an exterior surface of the earth-boring drill bit.

20. The earth-boring drill bit of claim 18, wherein the friction stir weld comprises a mixture of a material of each of the at least two portions.
